(19) United States
(12) Patent Application Publication
(10) Pub. No.: US 2012/0008868 A1
(43) Pub. Date: Jan. 12, 2012

(54) Video Image Event Attention and Analysis System and Method

(75) Inventors: Thomas Tsao, Potomac, MD (US); Xuemei Cheng, Rockville, MD (US)

(73) Assignee: COMPUSENSOR TECHNOLOGY CORP., Germantown, MD (US)

(21) Appl. No.: 12/832,144

(22) Filed: Jul. 8, 2010

(51) Int. Cl. G06K 9/62

(52) U.S. Cl. 382/224

(57) ABSTRACT

A video image event attention and analysis system comprising a video image input means, an event attention means, an event report means and a method comprising numerous steps of processes is provided for automatically detecting, analyzing, classifying events from input video image sequences. The changes in the event happen at some small part of visual world embedded in a largely persistent environment. Visual events are characterized through such duality. Accordingly, the method of this invention comprises processes first extracting features of the persistent environment and features of active agents, both are event specific, in separated channels, each followed by a corresponding recognition process, one for environment and one for active agents, and then the dynamical system of their coupling, particular their movements against environment and against each other, are analyzed and results are synthesized and interpreted in a process of hierarchical event classification.

### CROSS-REFERENCE TO RELATED APPLICATIONS

This application claims the benefit of the filing of U.S. Provisional Application Ser. No. 61/192,714 filed on Sep. 22, 2008 and entitled “Video and Image Analysis and Processing System”.

### BACKGROUND OF THE INVENTION

1. Field of the Invention

The invention relates to video and image data analysis systems and methods and more particularly to systems and methods of using digital computers for detecting and classifying events within the scope of a specific attention from video data. The invention further relates to a computational vision system comprising a plurality of computational modules for extracting environment invariants and changes, detecting and classifying active agents, particularly the moving objects and humans, and their activities and changes, and reporting the events of interest from the video images.

2. Description of the Related Art

The military, intelligence, law enforcement communities and commercial sector internet service providers, and other large volume video data holders have an ever increasing need to monitor live video feeds and search large volumes of archived video data for activities, objects, and events of interest. It is advantageous to use computer systems to provide automatic monitoring and searching which currently are performed by human analysts. Techniques of using digital computers for extracting visual information from video images including automatic object and human detection, recognition and tracking, moving target detection and indication, image-based change detection, video image geo-registration, object motion pattern learning, purposeful motion detection and classification, anomaly detection and classification, are developed for purposes different from that of video activity detection and event classification. These are related arts. Although the information extracted from these techniques is often useful for detection and classification of events from video images, none of these techniques address the issue of recognition of ecological events.

Computational theory on object recognition and image motion analysis was taught in a book by David Marr's entitled “Vision,” published by W.H. Freeman and Company in 1982. Psychophysical theory on optical information for visual perception of ecological events was taught in a book written by J. J. Gibson entitled “The Ecological Approach to Visual Perception,” published by Lawrence Erlbaum Associates, Inc. in 1979. Several thousands of research articles on object recognition and object tracking, image registration, and other computational vision topics were published in numerous academic journals. These published papers and books, and the current art of computational vision are primarily concerned with methods of using digital computers for detecting and recognizing of objects or persons from pictures, or detecting and tracking one or multiple objects through a sequence of video images. The current art of computational vision does not concern the particular visual information characterizing ecological events.

The ecological events, including the social events and human activities, are generally characterized by the system of two parties, the participating active agents and their local environment, and the dynamics of the system. Terming such a system an ecological event dynamical system, all techniques useful for analyzing this class of dynamical systems are of related arts.

### BRIEF SUMMARY OF THE INVENTION

This invention concerns a method and an apparatus for detecting and classifying a predetermined list of classes of ecological events, which may include social events and activities of human as a particular class, from video images. In accordance with the vision theory taught in Gibson's book, ecological events are spatiotemporal invariants extracted from optic data concerning the changes and movements among objects and humans and their relations with references to their environment, said invariants are organized in a hierarchical order, and classified as such.

Accordingly, it is an objective of this invention to provide a method and an apparatus for autonomously extracting the information from video images required from said list of classes of events, and detecting said events.

It is another object of this invention to provide a method and an apparatus for autonomously extracting information from video images for characterizing certain types of persistent environments within which the ecological events in said list of classes may happen.

It is another objective of this invention to provide a method and an apparatus for autonomously extracting information from video images for detecting of certain types of active agents involved in the classes of events in said list.

It is another objective of this invention to provide a method and an apparatus for autonomously extracting from video images the features of the persistent environment including statistical characterization of the ground surface, the objects attaching to or maintaining a persistent relation with the ground throughout some period of time durations, and relations among said features.

It is another objective of this invention to provide a method and an apparatus for autonomously extracting from video images the geometric/textural/kinetic features of active agents including invariant characteristics of changeable and moveable objects, animals, and humans.

It is another objective of this invention to provide a method and an apparatus for autonomously extracting from video images the information of the environment referenced changes of said active agents, including the measurement of the movements and changes of poses of said agents relative to the persistent environment features.

It is another objective of this invention to provide a method and an apparatus for autonomously extracting from video images the information of the mutually referenced changes of the interrelations of active agents, including their spatial relations and relations thereupon derived.

It is another objective of this invention to provide a method and an apparatus for autonomously classifying from movements and changes of active agents including both environmentally and mutually referenced movements, changes, and the respective events.

It is yet another objective of this invention to provide a method and an apparatus for autonomously and hierarchically classifying from said classified events to the events of levels higher than that already classified.

It is yet another objective of this invention to provide a method and an apparatus for autonomously keeping records of the information extracted from said event analysis.

It is yet another objective of this invention to provide a method and an apparatus for informing the system of specific requests by users and for reporting recognized events, and the availability of respective and relevant information by the system.

### BRIEF DESCRIPTION OF THE DRAWINGS

Exemplary embodiments of the invention are shown in the drawings and will be explained in detail in the description that follows.

FIG. 1 is a schematic diagram of a video image event attention and analysis system comprising a video image input channel, an attention activation module, an event detection and analysis engine, and an event reporter.

FIG. 2 is a schematic diagram of an event detection and analysis engine comprising a dual channel feature extractor, and a plurality of event analysis modules each for a particular category.

FIG. 3 is a schematic diagram of an event analysis module comprising an event specific environment recognition module, an event specific active agent recognition module, an event specific dynamical system analysis module, and a hierarchical event classification module.

FIG. 4 is a schematic diagram of a typical event specific environment recognition module comprising a terrain environment classification module, a road detection module, a landmark recognition module, a door, gate, window and furniture recognition module, a special interest point recognition module, and an event specific environment graph representation generation and maintenance module.

FIG. 5 is a schematic diagram of an event specific active agent recognition module comprising a moving object detection module, a human body/face detection module, an object recognition module, a face recognition module, a non-motion change detection module, and an active agent tracking and motion analysis module.

FIG. 6 is a schematic diagram of an event specific dynamical system analysis module comprising a ground track analysis module, an active agents relative motion analysis module, and an active agents environment referenced motion pattern analysis module.

FIG. 7 is a schematic diagram of a hierarchical event classification module comprising a simple event recognition module, an event spatial integration module, an event temporal integration module, and a hierarchical composite event recognition module.

### DESCRIPTION OF THE PREFERRED EMBODIMENT

This invention is a computer vision system built based upon Gibson's ecological approach to visual perception of ecological events. Ecological events perceived by human vision are those within the ecological scales of space and time, and happen in certain ecological environment. The ecological events, including the social events and activities of humans, are each involving a persisting component, which is the persistent local environment of the event, and a changing component which can be termed the active agent of the event. They form a dual system: the local event environment and the active agent of the event. The changes may happen in terms of movements of objects, animals and humans, or chemical, color, or texture changes of some part of objects in the local environment. A terrestrial event not only is limited in space, it is also limited in the time duration. The changes in a local ecological/social system constitute a dynamical system of finite duration. In his book, Gibson further gave a comprehensive description of typical ecological events in terms of the ways of changes of lights reflected from environment surfaces, and particularly the changes of ambient optic arrays wherefrom the retinal images are taken during the course of an event. During the course of an event, the assemblage of ambient optic arrays forming from lights reflected from the ecological environment surfaces involved in said event constitutes a dynamical system. The dynamical system constituting the assemblage of temporally changing optic arrays manifesting an ecological event can be termed the event optic dynamical system. A sample taken by video camera from the event optic dynamical system in the form of video images constitutes a measurement of said event optic dynamical system. Gibson pointed out that ecological events are accompanied by an event optic dynamical system, which is a mathematical object in a continuous domain of state space variables. The relation between ecological events and event optic dynamical system can readily be described with mathematical notion of mappings, and particularly with projections from the set of event optic dynamical systems to a discrete set of interpretation, i.e., a symbolic representation of events. Procedure of said projection can be carried out through sensory measurements in the form of video image sequences followed by further computational procedures conducting on said measurements. When the computational procedures applied on said measurements in the form of video images yield a symbolic representation assigned as the value of projection from the event optic dynamical system, the ecological event is said recognized from the video images. The invention is to provide a physical device and method to realize said computational procedure.

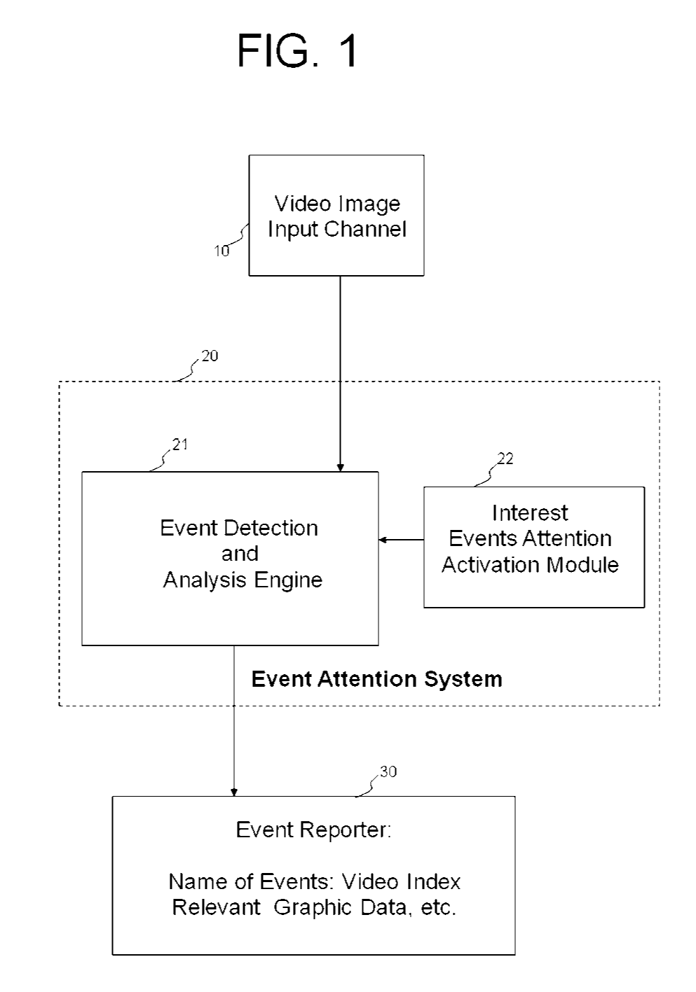

In accordance with the present invention and with reference to FIG. 1, the video image event attention and analysis system comprises an input channel 10 for receiving video image sequences, an events attention system 20 for analyzing video images and detecting and classifying events; said event attention system further comprises an interest event attention activation module 22 and an event detection and analysis engine 21 for processing and analyzing video image sequences and recognizing ecological/social events of the class of particular interest from video images upon receiving signals designating for said class of interest event attention activation modules wherever a proper sample of such event dynamical system presents in said input video image sequence, and sending the process results including the symbolic representation to said reporter 30.

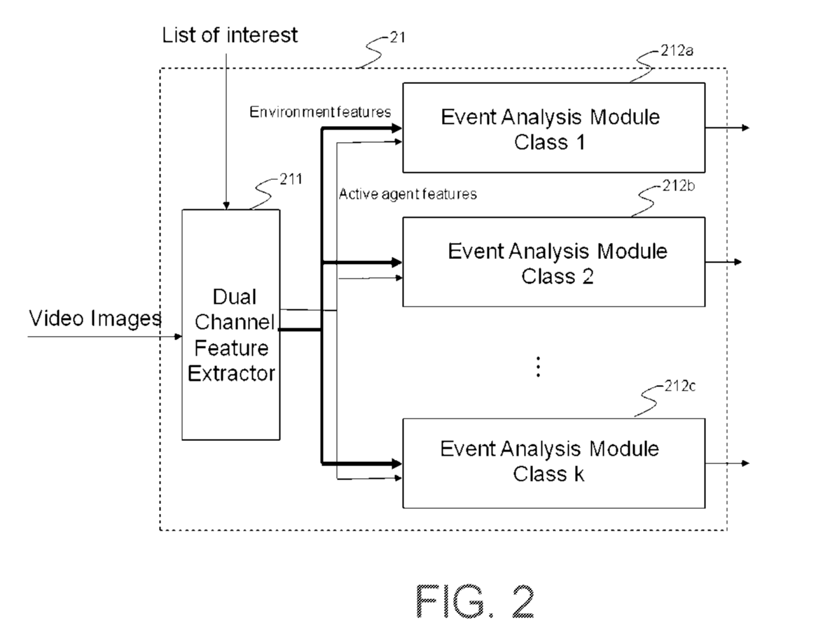

In accordance with this invention and with reference to FIG. 2, said event detection and analysis engine comprises a dual channel feature extractor 211 for receiving signals of video images and signals of a list of interest events and extracting specific class of environment features and active agent features in two of its processing channels, one for the environment features and one for the active agent features from video images, according to the list of interest events, and a plurality of event analysis modules 212, each for a specific class of events.

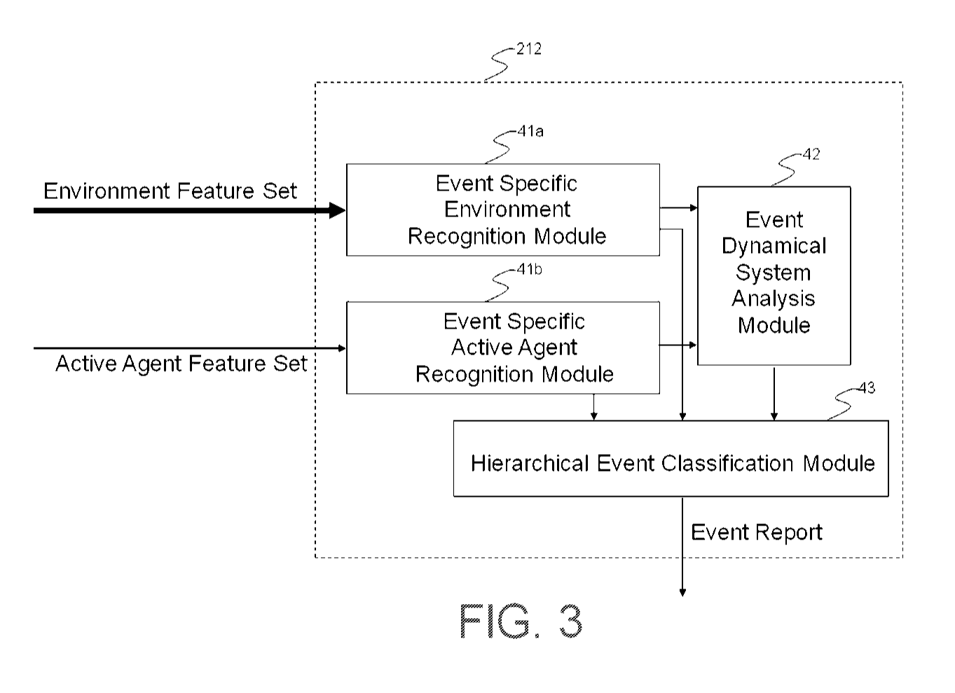

With reference to FIG. 3, a typical event analysis module comprises an event specific environment recognition module 41a, an event specific active agent recognition module 41b, an event specific dynamical system analysis module 42, and a hierarchical event classification module 43.

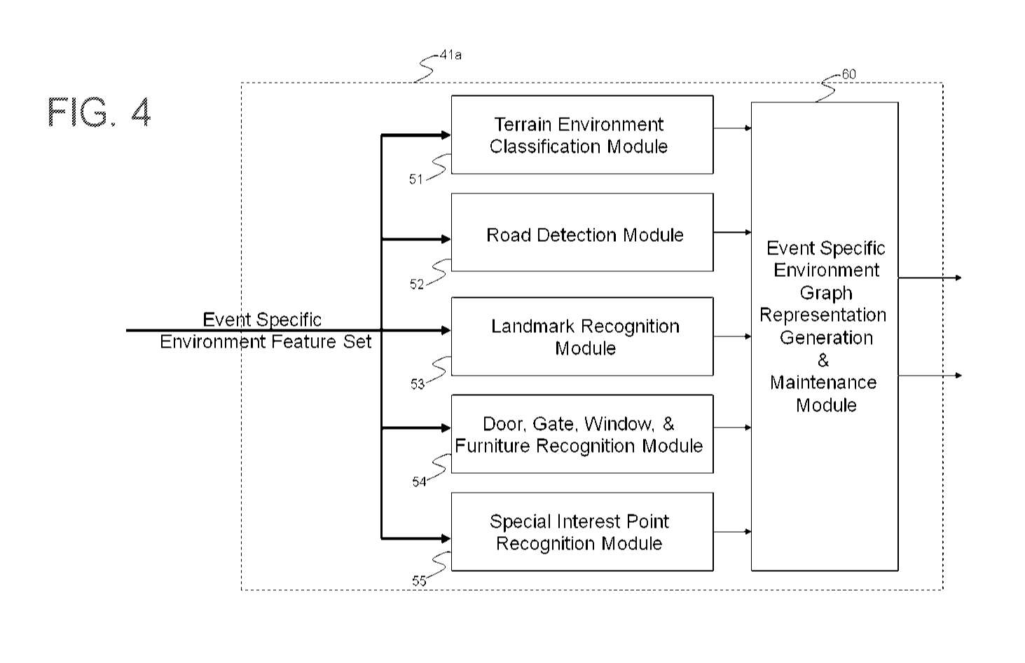

With reference to FIG. 4, in the preferred embodiment of this invention, a typical event specific environment recognition module comprises a terrain environment classification module 51 for receiving event specific environment feature set and classifying the terrain environment for a particular class of events, a road detection module 52 for detecting presence of road from event specific environment features it received, a landmark recognition module 53 for recognizing landmarks from the environment features it received for the specific class of event, a door, gate, window, & furniture recognition module 54 for recognizing and allocating said environment objects from received environment feature set, a specific interest point recognition module 55 for specifying events relating to certain particular interest points, and an event specific environment graph representation generation and maintenance module 60 for integrating the various recognized environment components in a graph representation of the persistent environment maintained throughout the event.

In the before referenced book written by Gibson, events are generally related to movements of objects and humans as well as non movement changes in a generally stable and persistent environment, and some events involve both movements and non movement changes. All visually perceptible events are related to changes in the structure of ambient optic arrays.

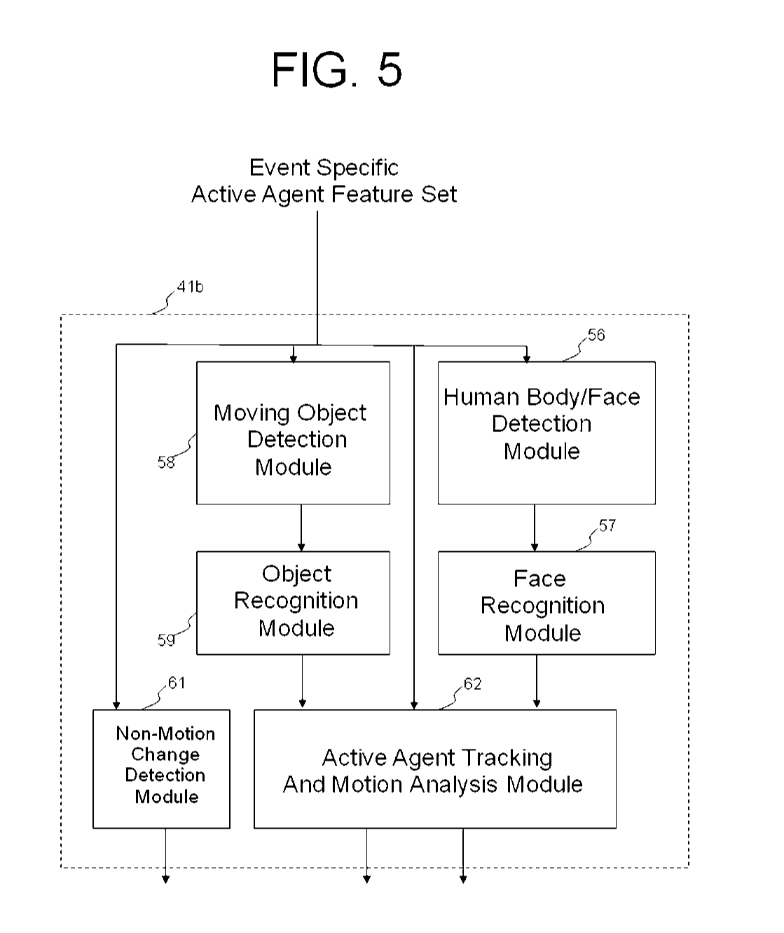

In accordance with this invention and with reference to FIG. 5, said event specific active agent recognition module further comprises a moving object detection module 58, an object recognition module 59, a human body/face detection module 56, a face recognition module 57, an active agent tracking and motion analysis module 62, a non motion change detection module 61.

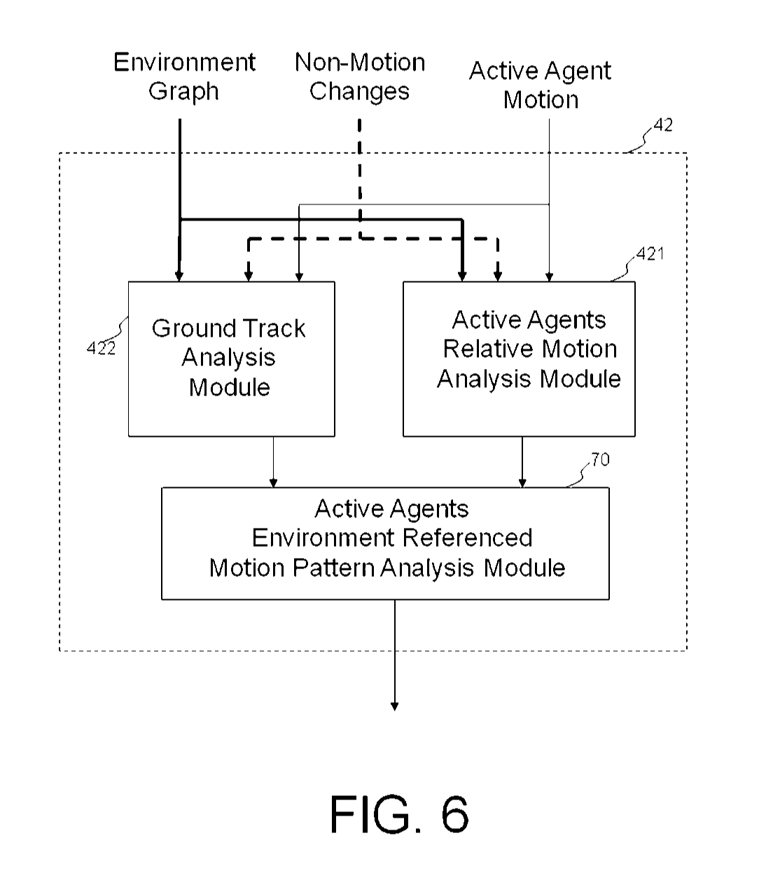

In accordance with this invention, with reference to FIG. 6, said event specific dynamical system analysis module comprises a ground track analysis module 42a for computing movement of objects or humans against the reference frame of the invariant environment, an active agents relative motion analysis module 42b for computing movements of objects and humans against each other, an active agents environment referenced motion pattern analysis module 70 for classifying patterns of motion of the active agents referencing to said event specific environment.

In accordance with Gibson's teachings, the flow of ecological events consists of natural units that are nested within one another—episodes within episodes, subordinate ones and superordinate ones.

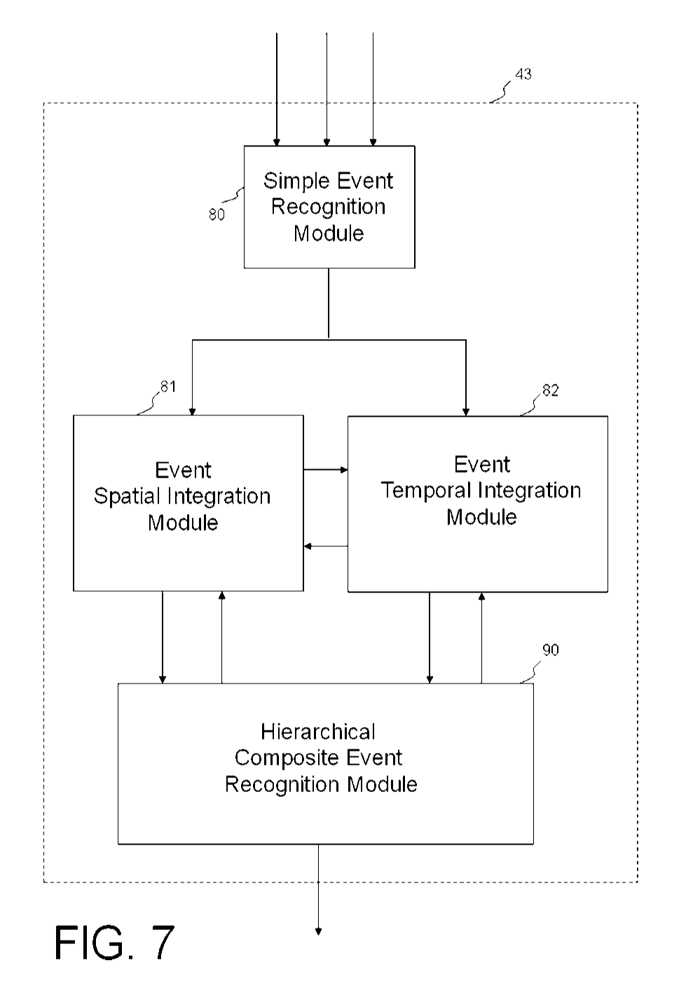

In accordance with this invention, with reference to FIG. 7, said hierarchical event classification module further comprises a simple event recognition module 80, an event spatial integration module 81, an event temporal integration module 82, and a hierarchical composite event recognition module 90.

Although the present invention has been described with reference to a preferred embodiment, the invention is not limited to the details thereof, various modifications and substitutions will occur to those of ordinary skill in the art, and all such modifications and substitutions are intended to fall within the spirit and scope of the invention as defined in the appended claims.

What is claimed is:

1. A video image event attention and analysis system for detecting and classifying events within the scope of a specific attention from video data comprising a video image input means for receiving signals of video images, an event attention means for receiving video image signals and providing event signals, and an event reporting means for receiving event signals and generating display and physical record signals;

2. the video image event attention and analysis system of claim 1, wherein said event attention means further comprising an interest events attention activation means for generating interest event list attention signals, an event detection and analysis means for receiving video image signals and interest event list attention signals and producing event signals;

3. the video image event attention and analysis system of claim 2, wherein said event detection and analysis means further comprising a dual channel feature extraction means for receiving video image signals and interest event list attention signals and generating environment feature signals and active agent feature signals, a plurality of event analysis means each for receiving environment feature signals and active agent feature signals and generating event signals;

4. the video image event attention and analysis system of claim 3, wherein said event analysis means further comprising an event specific environment recognition means for receiving environment feature signals and generating event specific environment representation signals, an event specific active agent recognition means for receiving active agent feature signals and generating active agent symbolic representation and motion/change signals, an event specific dynamical system analysis means for receiving event specific environment representation signals and active agent symbolic representation and motion/change signals, and generating ecological event dynamical system description signals, a hierarchical event classification means for receiving event specific environment representation signals, active agent symbolic representation and motion/change track signals, and ecological event dynamical system description signals, and generating event signals;

5. the video image event attention and analysis system of claim 4, wherein said event specific environment recognition means further comprising terrain environment classification means for receiving event specific environment feature signals and generating terrain environment classification signals, a road detection means for receiving event specific environment feature signals and generating road description signals, a landmark recognition means for receiving event specific environment feature signals and generating landmark representation signals, a building/room entry/exit place recognition means for receiving event specific environment feature signals and generating building/room entry/exit representation signals, an in-house furniture/fixture recognition means for receiving event specific environment feature signals and generating in-house furniture/fixture representation signals, a special interest point recognition means for receiving event specific environment feature signals and generating special interest point representation signals, an event specific environment representation means for receiving terrain environment classification signals, road description signals, land mark representation signals, building/room entry/exit representation signals, in-house furniture/fixture representation signals, special interest point representation signals and generating event specific environment representation and modification signals;

6. the video image event attention and analysis system of claim 4, wherein said event specific active agent recognition means further comprising a moving object detection means for receiving event specific active agent feature signals and generating moving object indication signals, an object recognition means for receiving moving object indication signals and generating moving object description signals, a human body/face detection means for receiving event specific active agent feature signals and generating human body/face indication signals, a face recognition means for receiving face/body indication signals and generating human description signals, an active agent tracking and motion analysis means for receiving moving object description signals, human description signals, and event specific active agent feature signals, and generating active agent symbolic representation and motion/change signals, a non-motion change detection means for receiving event specific active agent feature signals and generating non-motion change signals;

7. the video image event attention and analysis system of claim 4 wherein said event specific dynamical system analysis means further comprising a ground track analysis means for receiving event specific environment representation and modification signals, active agent symbolic representation and motion/change signals, and non-motion change signals and generating active agent ground track description signals, an active agents relative motion analysis means for receiving event specific environment representation and modification signals, active agent symbolic representation and motion/change signals, and non-motion change signals and generating active agent relative motion signals, an active agents environment referenced motion pattern analysis means for receiving active agent ground track description signals and active agent relative motion signals and generating active agents environment referenced motion pattern description signals;

8. the video image event attention and analysis system of claim 4, wherein said hierarchical event classification means further comprising a simple event recognition means for receiving event specific environment representation and modification signals, non-motion change signals, and active agents environment referenced motion pattern description signals and generating simple event description signals, an event spatial integration means for receiving simple event description signals and composite event description signals and generating spatial integrated event signals, an event temporal integration means for receiving simple event description signals and composite event description signals and generating temporal integrated event signals, a hierarchical composite event recognition means for receiving spatial integrated event signals and temporal integrated event signals and generating composite event description signals.

9. in a video image event attention and analysis system including a video image input means for receiving signals of video images, an event attention means for receiving video image signals and providing event signals, and an event reporting means for receiving event signals and generating display and physical record signals, a method for detecting and classifying events within the scope of a specific attention from video data comprising the steps of: activating event attention and analysis system for a list of event classes of interest; taking in video images; detecting and recognizing events of one of the listed event classes from video images, and reporting the recognized events;

10. the method of claim 9, wherein said step of detecting and recognizing events further comprising a step of dual channel video image feature extraction and a step of event analysis;

11. the method of claim 10, wherein said step of dual channel video image feature extraction further comprising a step of event specific environment feature extraction and a step of active agent feature extraction, both from input video image data;

12. the method of claim 10, wherein said step of event analysis further comprising a step of event specific environment recognition, a step of event specific active agent recognition, a step of event dynamical system analysis, and a step of hierarchical event classification;

13. the method of claim 12, wherein said step of event specific environment recognition further comprising steps of terrain environment classification, of road detection, of landmark recognition, of building/room entry/exit place recognition, of special interest point recognition, and of event specific environment representation generation and maintenance;

14. the method of claim 12, wherein said step of event specific active agent recognition further comprising steps of moving object detection, of human body/face detection, of object recognition, of face recognition, and of active agent tracking and motion analysis, and of non-motion change detection;

15. the method of claim 12, wherein said step of event dynamical system analysis further comprising a step of ground track analysis, a step of active agent relative motion analysis, and a step of active agents environment referenced motion pattern analysis;

16. the method of claim 12, wherein said step of hierarchical event classification further comprising a step of simple event recognition, a step of event spatial integration, a step of event temporal integration, and a step of hierarchical composite event recognition;
